(19) United States
(12) Patent Application Publication
(10) Pub. No.: US 2024/0076525 A1
(43) Pub. Date: Mar. 7, 2024

(54) METHOD OF USING A TECHNICAL ADHESIVE TAPE

(71) Applicants: Timo LEERMANN, Wuppertal (DE); Rene RAMBUSCH, Wuppertal (DE)

(72) Inventors: Timo LEERMANN, Wuppertal (DE); Rene RAMBUSCH, Wuppertal (DE)

(21) Appl. No.: 18/382,542

(22) Filed: Oct. 23, 2023

Related U.S. Application Data
(62) Division of application No. 16/574,610, filed on Sep. 18, 2019.

(30) Foreign Application Priority Data
Sep. 28, 2018 (DE) 202018105611.5

(51) Int. Cl. C09J 7/38; C08K 3/34; C09J 7/20; C09J 11/00

(52) U.S. Cl. CPC C09J 7/38; C08K 3/34; C09J 7/20; C09J 11/00; C08K 3/04; C08K 3/346; C09J 2203/302; C09J 2301/302; C09J 2301/408; C09J 2301/41; C09J 2400/263; C09J 2421/00; C09J 2423/046; C09J 2433/00; C09J 2467/006; C09J 2475/006; C09J 2477/006

(57) ABSTRACT

A substrate strip is provided on at least one face with a coating of hot-melt adhesive containing an odor-control powder of clay, zeolite, cyclodextrin, or a combination thereof incorporated into the adhesive in a grammage of at least 0.1% to 10% by weight based on a total mass of the adhesive to form an adhesive tape. This tape is then wrapped around a plurality of cables in an automobile.

### CROSS REFERENCE TO RELATED APPLICATION

This application is a division of U.S. application Ser. No. 16/574,610 filed 18 Sep. 2019 with a claim to the priority of German application 20 2018 105 610.5 itself filed 28 Sep. 2018.

### FIELD OF THE INVENTION

The invention relates to a technical adhesive tape, particularly a pressure-sensitive adhesive tape and preferably a tape for wrapping cables in automobiles, comprising a substrate strip and a coating of adhesive on at least one face of the substrate strip.

### BACKGROUND OF THE INVENTION

Technical adhesive tapes are typically used in the construction sector. Noteworthy examples include insulating tapes, anticorrosion tapes, aluminum adhesive tapes, film adhesive tapes, etc. In addition, such technical tapes can be used as a protective covering or protective film to protect sensitive surfaces during transport from scratches, to prevent corrosion inter alia on metal support surfaces, etc. An example of such a technical adhesive tape is described in DE 103 59 630.

Since such technical adhesive tapes typically have to adhere to rough and sometimes dusty, slightly damp, or cold surfaces, adhesives are generally used that have a high pressure-sensitive tackiness and are additionally pressure-sensitive, unlike adhesive tapes used in the medical sector, for example. High adhesion happens to not be crucial in this context, and very different requirements such as the skin tolerance play a role. Very especially preferably, the invention relates to special technical adhesive tapes, namely cable-wrapping tapes.

Cable-wrapping tapes as they have become known, for example, by the category-defining document US 2015/0203721 are generally used to group a plurality of cables together in automobiles by wrapping or sheathing. For this purpose, the cable-wrapping tape in question is usually wound helically around the cables to be gathered together. A quasitubular wrapping in the longitudinal direction of the cable is also possible, however, and expressly intended in the context of the invention.

In view of the described intended use, it is important, on the one hand, that such cable-wrapping tapes for wrapping cables in automobiles be resistant to elevated temperatures, oil, gasoline, etc. because the cables in question are often installed in the engine compartment. In addition, and on the other hand, low transverse tearing forces are usually required for handling of such cable wraps in order make them manually tearable transversely without additional tools such as knives, scissors, etc.

When it comes to cables in automobiles, or automotive parts in automobiles in general, which are made of rubber or plastic, the fundamental problem arises just like with the cable-wrapping tapes sheathing the cables that unpleasant odors from vapors are oftentimes observed here that are perceived by users as objectionable. These vapors are often attributed to solvents used in this context during processing. For this reason, there is growing demand in practice that the products used contain no solvents that are known to those skilled in the art as VOC's (volatile organic compounds). Adhesive coatings with water-based adhesives are used for this reason, for example, but they have reduced bond strength compared to solvent-based adhesive systems.

Furthermore, in for example the prior art according to DE 10 2008 038 421, a specially embossed PVC film is used as the substrate strip. This requires a special approach with a low embossing depth in the micrometer range. What is more, additives are mixed in with the PVC film. As a result, manufacture is relatively expensive. Moreover, it has been found that the absence of solvents cannot solve the problem of odor generation in practice, at least not completely.

### OBJECTS OF THE INVENTION

It is therefore an object of the present invention to provide an improved technical cable-wrapping adhesive tape.

Another object is the provision of such an improved technical cable-wrapping adhesive tape that overcomes the above-given disadvantages, in particular that can be manufactured inexpensively.

Another object of the invention is to further develop such a tape for wrapping cables in automobiles in such a way that objectionable odors are suppressed or at least largely attenuated in a simple manner.

### SUMMARY OF THE INVENTION

A technical adhesive tape for wrapping cables in automobiles has according to the invention, a substrate strip, a coating of adhesive on at least one face of the substrate strip, and an odor-control agent incorporated in the adhesive coating and/or the substrate strip.

### SPECIFIC DESCRIPTION OF THE INVENTION

For the sake of example and without limitation, the odor-control agents that are suitable here include inorganic absorbing agents that are normally powder or exist in granular form, and here minerals such as clays or silicates in general, for example. In particular, the use of zeolites, i.e. tectosilicates that form open cavities in the form of channels and cages for the attachment of molecules, is recommended. Other absorbing agents such as activated carbon can however also be used.

Furthermore, the use of organic absorbing agents such as cyclodextrin, for example, has been found to be beneficial. Cyclodextrins are a class of compounds belonging to the cyclic polysaccharides. They provide annular decomposition products of starch with a toroidal structure and a central cavity that, again, serves and can be used for the attachment of molecules, more particularly odor molecules. Given that they are used in the food industry in some cases, cyclodextrins and cyclodextrin derivatives are altogether harmless and can bind sweat odor, for example, for the reasons described.

That is, the invention advantageously makes use of powders and/or granules as odor-control agents that are especially easy to process. For this purpose, the powder or the granules in question can easily be added to a base material during the manufacture of the adhesive or of the substrate strip. What is more, the absorbing agents described are harmless to health, meaning that they can be easily used for manual processing as cable-wrapping tape for wrapping cables in automobiles. By using both organic absorbing agents and inorganic mineral absorbing agents, a wide range of suitable materials is available that can be offered and processed at a low price by virtue of their being otherwise widely used. It will of course be readily understood that the above-described odor-control agents can be used both individually and in combination.

Overall, and surprisingly, it was found in the context of the present invention that the odor-control agents in question are able to absorb not only human odors.

Instead, the odor-control agents are also suitable in principle and can be used to absorb vapors due to solvents used in the production of plastics, for example, as well as other previously uncontrollable odors during the processing of cable-wrapping tapes and the trappings associated with cables in automobiles. At the same time, the respective powdered granular absorbing agents can be easily incorporated into a substrate strip and/or an adhesive for making an adhesive coating in connection with the production of a cable-wrapping tape, particularly without compromising the required properties of such cable-wrapping tapes in terms of media and temperature resistance or the manual tearability thereof. The adhesive properties of the adhesive are also not adversely affected. This could not be expected to this degree of consistency and is surprising.

According to another advantageous embodiment, the odor-control agent in question is present in the adhesive and/or substrate strip in a grammage of no more than 20% by weight based on the total mass of the respective adhesive or substrate strip. In particular, even a maximum proportion of 10% by weight of the grammage of the odor-control agent based on the total mass is recommended. This limit ensures that the properties of the substrate strip and/or adhesive are not significantly altered compared to a substrate strip or adhesive without an odor-control agent added.

Moreover, the invention recommends that the odor-control agent be used in a grammage of at least 0.1% by weight and preferably of at least 0.2% by weight, again based on the total mass of the adhesive and/or substrate strip. Such a minimum amount is required in order to effectively absorb or eliminate the odors that typically arise during processing of the cable-wrapping tape or other odors in the environment. A grammage range of the odor-control agent of from 0.1% by weight to 8% by weight and preferably 0.2% by weight to 6% by weight, each based on the total mass of the adhesive or substrate strip, has been found to be especially preferred.

The odor-control agent can be processed not only in powder form or as granules. Instead, it is also possible in the context of the invention to introduce the odor-control agent not only in pure form, but also in dissolved, dispersed, and/or microencapsulated form into the adhesive for the adhesive coating and/or substrate strip. That is, the above dosage forms of the odor-control agent are to be considered both as alternatives and in combination. For example, the odor-control agent may be a powder that is incorporated into an adhesive composition. For example, a dispersion that is additionally provided according to the invention with the odor-control agent in powder form can be used as adhesive. The adhesive composition obtained in this way can then be sprayed, knife-coated, or otherwise applied to the substrate strip in question like for example the original dispersion. The dispersion in question can for example be acrylate-based.

The procedure is similar if a hot-melt adhesive is used as adhesive. This hot-melt adhesive may be made on the basis of acrylate or rubber. In that case as well, the odor-control agent can be easily and inexpensively introduced into the hot-melt adhesive in question as a powder and applied together with it to the substrate strip by for example a spray nozzle. Alternatively and additionally, it is also possible in principle to use adhesives based on silicone, polyurethane, polyether, and polyolefin. In any case, the processing and adapting of a suitable adhesive composition for the preparation of the adhesive coating according to the invention can be achieved in an especially simple and cost-effective manner if, in the exemplary case, the odor-control agent is mixed into the adhesive composition in question as a powder and incorporated therein.

The same applies to a case in which the odor-control agent is incorporated into the adhesive composition in microcapsules. In this case as well, the processing of the adhesive composition as a dispersion or hot-melt adhesive can be carried out in a similar manner as described above. In both cases, virtually nothing changes in the production of the adhesive coating through the addition of the odor-control agent, for which reason low production costs can be expected. The extra costs can be reduced substantially to the supplementary material used in the form of the odor-control agent.

Alternatively or in addition, however, the odor-control agent can also be incorporated into a substrate strip. This applies both to a case in which the odor-control agent is available as a powder or granules, as well as one in which the odor-control agent is present in the form of microcapsules. Finally, the odor-control agent can also be incorporated easily into the substrate strip composition as an aqueous or other solution. After all, the substrate strip is advantageously a textile fabric made of fibers and/or filaments.

Fibers or filaments that are typically used for the substrate strip are typically plastics such as polyester, polyamide, polyethylene, polypropylene, polyurethane, polyacetate, or natural materials such as cotton or viscose and mixtures thereof. The fibers in question and the plastic fibers or cotton or viscose fibers made therefrom can be easily provided with the odor-control agent in their substrate strip. For this purpose, the odor-control agent in question is added, for example, as a powder, granules, or in microcapsules or as a solution, for example, to a plastic granulate that, in turn, is then used to make the desired fibers. This can be done by a known spinneret method.

However, instead of a substrate strip as described above and embodied as a textile fabric substrate strip, it is also possible to work with a substrate strip that is a film. Such a textile or film substrate strip can be made, for example, from plastics such as PVC (polyvinyl chloride), polyethylene (PE), polypropylene (PP), etc. In this case as well, the odor-control agent can be introduced and incorporated into the granulate that is used to produce the film, in for example powdered form or as a dispersion, in a similar manner as already described in connection with the production of the fibrous filamentous materials for the substrate strip. In principle, the substrate strip can also be embodied as a laminate of a film with for example a textile substrate strip.

Among the conceivable adhesives for the cable-wrapping tape according to the invention, those based on acrylate have proven to be especially favorable. They for example can be applied as dispersions. Hot-melt adhesives based on acrylate and/or rubber as well as mixtures thereof are however also conceivable.

In all cases, the odor-control agent in question can be incorporated with particular ease into the adhesive composition or the adhesive for making the adhesive coating as well as into the substrate strip. This is especially advantageous if the odor-control agent in question is present as a powder and is introduced for example in this case into a granulate for preparing the adhesive and/or fibers of the substrate strip and/or the granulate for producing the film.

As a whole, the invention takes account the fact that even small concentrations by weight of the odor-control agent in the adhesive coating or in the substrate strip are sufficient to produce the desired odor-binding effect, regardless of whether any harmful odors are made by the cable wrap, the sheathed cables, or by other materials located in the environment. Due to the small proportion of the odor-control agent in the adhesive coating or the substrate strip, and in consideration of a maximum grammage of 20% by weight and, in particular, of 10% by weight, it can be expected that the processing of the adhesive composition or of the substrate strip composition will be practically unaffected compared to a procedure without the addition of the odor-control agent. This is especially true if a maximum of 10% by weight of the odor-control agent for the entire cable-wrapping tape is adhered to as the upper limit. These 10% by weight can be distributed completely on the adhesive or the substrate strip, for example, or half can also be in the adhesive and half in the substrate strip, or the distribution can be performed in any combination. In any case, the production of the cable-wrapping tape is not negatively influenced overall if these specifications are taken into account.

The same applies to the adhesive properties of the adhesive coating as well as to the properties of the substrate strip, for example in terms of tensile strength in the longitudinal direction, manual tearability, etc. That is, as long as the odor-control agent in question is present in the specified grammage range with a maximum proportion of 10% by weight in the cable-wrapping tape in question, the mechanical properties of the cable-wrapping tape concerned are not otherwise affected or practically not adversely affected. This is true even if for example the cable-wrapping tape is additionally dyed. In that case, the dye particles in question as well as the particles of the odor-control agent can be incorporated together into the plastic granulate to be made into the adhesive or the substrate strip.

The cable-wrapping tape made in this manner typically has a weight per unit area in the range from 20 g/m² to 500 g/m² with respect to its substrate strip. In particular, a weight per unit area of the substrate strip in the range from 50 g/m² to 200 g/m² is observed. The thickness of the substrate strip is usually below 0.8 mm. Preferably, a thickness of the substrate strip in the range of less than 0.5 mm is generally used in order to provide the desired manual tearability.

The adhesive coating is generally present in an applied weight of between 20 g/m² to 200 g/m², and more preferably in the range from 50 g/m² to 150 g/m². Without limitation thereto, synthetic rubber adhesives, hot-melt adhesives, or acrylate-based adhesives (with or without solvents) can be considered for use as suitable adhesives. Likewise, the invention includes adhesives based on silicone, polyurethane, polyether, and polyolefin. Moreover, the adhesives in question can be cross linked after the coating as needed, for example by radiation. In addition, adhesives in powder form, dispersion adhesives, etc., are conceivable. To apply the adhesive or the adhesive coating, methods such as, for example, direct coating or also transfer coating or also contactless coating according to the “curtain coating” method can be used and advantageously taken into account.

We claim:

1. A method comprising the steps of:
providing a substrate strip;
applying to at least one face of the strip a coating of hot-melt adhesive containing an odor-control powder of clay, zeolite, cyclodextrin, or a combination thereof incorporated into the adhesive in a grammage of at least 0.1% to 10% by weight based on a total mass of the adhesive to form an adhesive tape; and
wrapping the adhesive tape around a bundle of cables in an automobile.

2. The adhesive tape according to claim 1, wherein the odor-control powder is present in the adhesive and/or substrate strip in a grammage of no more than 20% by weight.

3. The method according to claim 1 wherein the powder is present in pure form in the adhesive coating.

4. The method according to claim 1, wherein the odor-control powder is organic and/or mineral.

5. The method according to claim 1, wherein the substrate strip is a textile fabric made of fibers and/or filaments.

6. The method according to claim 5, wherein fibers and/or filaments for the substrate strip are of polyester, polyamide, polyethylene, polypropylene, polyurethane, polyacetate, cotton, viscose, or mixtures thereof.

7. The method according to claim 1, wherein the substrate strip is a plastic film based on polyvinyl chloride, polyethylene, or polypropylene.
